(19) United States
(12) Patent Application Publication
(10) Pub. No.: US 2025/0237279 A1
(43) Pub. Date: Jul. 24, 2025

(54) ELECTRIC BRAKE DEVICE

(71) Applicant: AISIN CORPORATION, Kariya (JP)

(72) Inventor: Ken KATO, Kariya-shi (JP)

(73) Assignee: AISIN CORPORATION, Kariya (JP)

(21) Appl. No.: 18/978,560

(22) Filed: Dec. 12, 2024

(30) Foreign Application Priority Data
Jan. 24, 2024 (JP) 2024-008977
Jul. 24, 2024 (JP) 2024-118575

(51) Int. Cl. F16D 65/18; F16D 121/24; F16D 125/40

(52) U.S. Cl. CPC F16D 65/18; F16D 2121/24; F16D 2125/40

(57) ABSTRACT

An electric brake device includes: a motor; a rotation shaft provided with a parking screwing portion and a braking screwing portion having a common central axis, the rotation shaft being rotated by the motor; and a piston including a parking piston portion and a braking screwing portion, the parking piston portion moving in an axial direction of the central axis and pressing a brake pad when the rotation shaft rotates in one rotation direction in a state in which the parking piston portion is screwed to the parking screwing portion, and the braking piston portion moving in the axial direction together with a movement of the parking piston portion in a direction away from the brake pad in the axial direction and pressing the brake pad when the rotation shaft rotates in the other rotation direction opposite to the one rotation direction in a state in which the braking piston portion is screwed to the braking screwing portion.

### CROSS REFERENCE TO RELATED APPLICATIONS

This application is based on and claims priority under 35 U.S.C. § 119 to Japanese Patent Application 2024-008977, filed on Jan. 24, 2024, and Japanese Patent Application 2024-118575, filed on Jul. 24, 2024, the entire content of which is incorporated herein by reference.

### TECHNICAL FIELD

This disclosure relates to an electric brake device.

### BACKGROUND DISCUSSION

In the related art, an electric brake device including a motor is known (see, for example, JP 2006-142935A (Reference 1)).

Reference 1 discloses an electric brake device including a motor, a rotation shaft rotated by the motor, and a single piston screwed to the rotation shaft. The piston moves forward and backward in an axial direction in accordance with the rotation of the rotation shaft. The piston presses a brake pad against a brake disc to brake the brake disc (tire). That is, the electric brake device is used as a so-called service brake as a brake during normal driving.

The electric brake device further includes a ratchet mechanism for maintaining a parking state by maintaining a state in which the brake pad is pressed against the brake disc by the piston. The ratchet mechanism is driven by an electric solenoid and locks movement of the piston in a state in which the brake pad is pressed against the brake disc, to maintain the parking state. That is, the electric brake device is also used as a parking brake.

However, in the electric brake device according to Reference 1, both the motor and the electric solenoid are required for braking and parking brake as a drive source. In the related art, an electric brake device is required to reduce the number of components in a drive source for braking and parking brake.

A need thus exists for electric brake device which is not susceptible to the drawback mentioned above.

### SUMMARY

According to an aspect of this disclosure, an electric brake device includes: a motor; a rotation shaft provided with a parking screwing portion and a braking screwing portion having a common central axis, the rotation shaft being rotated by the motor; and a piston including a parking piston portion and a braking piston portion, the parking piston portion moving in an axial direction of the central axis and pressing a brake pad when the rotation shaft rotates in one rotation direction in a state in which the parking piston portion is screwed to the parking screwing portion, and the braking piston portion moving in the axial direction together with a movement of the parking piston portion in a direction away from the brake pad in the axial direction and pressing the brake pad when the rotation shaft rotates in the other rotation direction opposite to the one rotation direction in a state in which the braking piston portion is screwed to the braking screwing portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side cross-sectional view illustrating an electric brake device and a tire according to a first embodiment;

FIG. 2 is a side cross-sectional view of the electric brake device according to the first embodiment, and illustrates a parking state caused by a parking piston portion;

FIG. 3 is a side cross-sectional view of the electric brake device according to the first embodiment, and illustrates a braking state caused by a braking piston portion;

FIG. 4 is a side cross-sectional view illustrating an electric brake device according to a second embodiment;

FIG. 5 is a side cross-sectional view illustrating an electric brake device according to a third embodiment;

FIG. 6 is a view illustrating switching among a braking state, a neutral state, and a parking state of the electric brake device according to the third embodiment;

FIG. 7 is a side cross-sectional view illustrating a rotation shaft, a parking piston portion, and a braking piston portion of an electric brake device according to a first modification;

FIG. 8 is a side cross-sectional view illustrating a rotation shaft, a parking piston portion, and a braking piston portion of an electric brake device according to a second modification; and

FIG. 9 is a side cross-sectional view illustrating a rotation shaft, a parking piston portion, and a braking piston portion of an electric brake device according to a third modification.

### DETAILED DESCRIPTION

Hereinafter, embodiments disclosed here will be described with reference to the drawings.

### First Embodiment

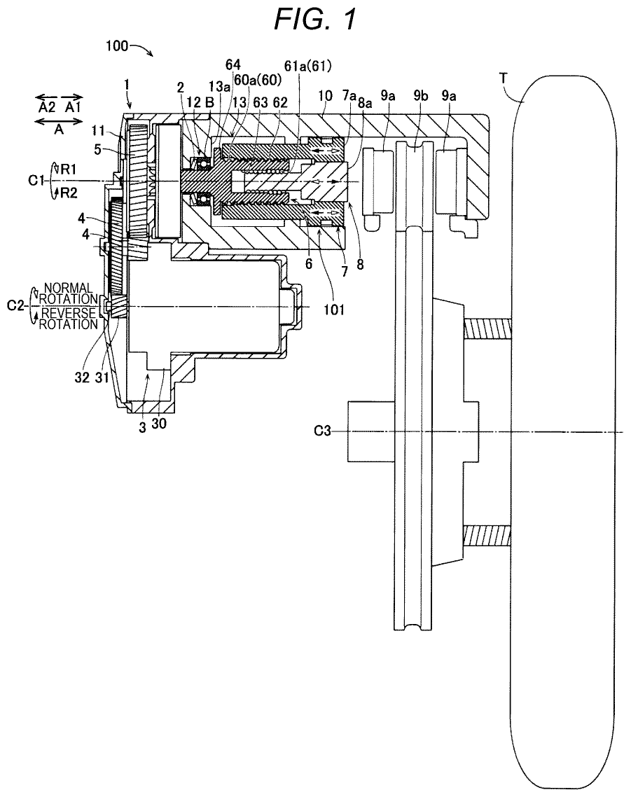

A configuration of an electric brake device 100 according to a first embodiment will be described with reference to FIGS. 1 to 3.

The electric brake device 100 illustrated in FIG. 1 is an electric brake device provided on a tire T of a vehicle. The electric brake device 100 is used to brake the tire T (a disc rotor 9b) and to maintain a parking state of the vehicle. The electric brake device 100 may be provided only on some of the tires T such as only a front wheel or only a rear wheel, or may be provided on all the tires T.

The electric brake device 100 is mounted on a shift-by-wire vehicle in which shift switching control is performed based on an operation signal from a shift switching operation unit provided with a shift sensor. As an example, when a control unit receives an operation signal for switching from a parking release state to a parking state from the shift switching operation unit, the electric brake device 100 is drive-controlled to perform an operation for switching from the parking release state to the parking state.

Here, in the drawings, an axial direction of a central axis C1 of a rotation shaft 6 of the electric brake device 100 is indicated as an A-direction. In the A-direction, a pressing direction of a brake pad 9a by a parking piston portion 7 and a braking piston portion 8 to be described below is indicated as an A1-direction, and an opposite direction thereof is indicated as an A2-direction. The central axis C1 is also a common central axis of a parking screwing portion 60 and a braking screwing portion 61 to be described below. A central axis C2 of a motor shaft 32 of a motor 3 and a central axis C3 of the disc rotor 9b (tire T) also extend in the A-direction.

In the drawings, one rotation direction of the rotation shaft 6 is indicated by an R1-direction, and the other rotation direction opposite to the one rotation direction of the rotation shaft 6 is indicated by an R2-direction. As an example, the rotation shaft 6 rotates in the one rotation direction (R1-direction) during the normal rotation of the motor 3, and the rotation shaft 6 rotates in the other rotation direction (R2-direction) during the reverse rotation of the motor 3. As an example, during the normal rotation of the motor 3, the parking piston portion 7 moves in the A1-direction, and the braking piston portion 8 simultaneously moves in the A2-direction. During the reverse rotation of the motor 3, the parking piston portion 7 moves in the A2-direction, and the braking piston portion 8 simultaneously moves in the A1-direction.

The electric brake device 100 includes a housing 1, a biasing member 2, the motor 3 that is a drive source, a transmission gear 4 that transmits a driving force of the motor 3, a driven gear 5 that is rotated by the driving force of the motor 3 transmitted through the transmission gear 4, the rotation shaft 6 that is rotated together with the driven gear 5 by the motor 3, a piston 101, the brake pad 9a, and the disc rotor 9b. The piston 101 includes the parking piston portion 7 and the braking piston portion 8. The parking piston portion 7 and the braking piston portion 8 directly come into contact with the brake pad 9a and press the brake pad 9a. The parking piston portion 7 and the braking piston portion 8 come into contact with the brake pad 9a at different timings. The piston 101 includes only one parking piston portion 7. That is, the parking piston portion 7 is a single structure. The piston 101 includes only one braking piston portion 8. That is, the braking piston portion 8 is a single structure.

### Configuration of Housing

The housing 1 accommodates the parts (the motor 3, the transmission gear 4, the driven gear 5, the rotation shaft 6, the parking piston portion 7, the braking piston portion 8, the biasing member 2, and the brake pad 9a) of the electric brake device 100. A part of the disc rotor 9b facing the brake pad 9a is accommodated in the housing 1.

The housing 1 can be divided into a plurality of members in consideration of ease of assembly. Specifically, the housing 1 includes a tubular housing body 10 and a lid member 11. The rotation shaft 6, the parking piston portion 7, the braking piston portion 8, and the like are accommodated in the tubular housing body 10. The lid member 11 is attached to the tubular housing body 10 from an A2-direction side.

The housing 1 is provided with a bearing accommodation recessed portion 12 in which a bearing B for rotatably supporting the rotation shaft 6 is accommodated. The bearing accommodation recessed portion 12 is an annular recessed portion in which the bearing B is disposed. The bearing accommodation recessed portion 12 is formed to be recessed in the A2-direction along the rotation shaft 6 from a piston accommodation region 13, which accommodates the parking piston portion 7 and the braking piston portion 8, inside the housing 1. The biasing member 2 is disposed on a bottom surface of the bearing accommodation recessed portion 12. That is, the biasing member 2 is disposed between the bottom surface (housing 1) of the bearing accommodation recessed portion 12 on the A2-direction side and the rotation shaft 6 on an A1-direction side in the axial direction (A-direction). Therefore, the bearing B is disposed between the biasing member 2 and the rotation shaft 6 in the axial direction (A-direction). In the axial direction (A-direction), the bottom surface (housing 1) of the bearing accommodation recessed portion 12, the bearing B, and the biasing member 2 are normally held in an abutting state.

An inner bottom surface 13a which is provided in the housing 1 and located on the A2-direction side of the piston accommodation region 13 is in surface contact with a flange portion forming an abutting portion 64 of the rotation shaft 6 to be described below in the parking state. More details will be described below.

### Configuration of Biasing Member

As an example, the biasing member 2 is a so-called disc spring. The biasing member 2 is formed in an annular shape surrounding the rotation shaft 6 having the central axis C1. The biasing member 2 extends along the bottom surface which is an end surface of the bearing accommodation recessed portion 12 in the A2-direction. The biasing member 2 has a relatively high rigidity, and is deformed (contracted in the A-direction) only by receiving a large compressive force in the A-direction. The biasing member 2 is held in a non-deformed state during the parking release state including a braking state of the disc rotor 9b caused by the braking piston portion 8. On the other hand, the biasing member 2 is held in a deformed state during the parking state.

### Configurations of Motor and Transmission Gear

The motor 3 includes a motor body 30 and the motor shaft 32 provided with a motor gear 31. The motor 3 is arranged side by side at a position in a direction intersecting the A-direction relative to the rotation shaft 6 to which the driving force is to be transmitted. That is, the motor 3 is not a direct-acting motor directly causing the rotation shaft 6 to rotate, but indirectly causes the rotation shaft 6 to rotate. The transmission gear 4 is disposed between the motor shaft 32 and the rotation shaft 6 in a direction intersecting the A-direction. A plurality of transmission gears 4 are provided and decelerate the output of the motor 3 and transmit the decelerated output to the rotation shaft 6. The transmission gears 4 are rotatably supported by bearings (not illustrated). As an example, the motor gear 31 and the transmission gear 4 are implemented by spur gears.

### Configuration of Driven Gear and Rotation Shaft

The driven gear 5 is provided on the rotation shaft 6. The driven gear 5 and the rotation shaft 6 have the common central axis C1. As an example, the driven gear 5 is implemented by a spur gear.

The rotation shaft 6 is configured to move the parking piston portion 7 and the braking piston portion 8 in the axial direction (A-direction). Specifically, the rotation shaft 6 is provided with the parking screwing portion 60 and the braking screwing portion 61 having the common central axis C1.

The parking screwing portion 60 is a parking male screw that is provided on an outer peripheral surface 62 of the rotation shaft 6 and screwed to the parking piston portion 7. The rotation shaft 6 is formed in a cylindrical shape having the outer peripheral surface 62 provided with the parking male screw. Therefore, the parking piston portion 7 is provided with a female screw that is screwed to the parking male screw which is the parking screwing portion 60 of the rotation shaft 6. A screwing portion between the parking screwing portion 60 and the parking piston portion 7 is implemented by a trapezoidal screw 60a. In the parking screwing portion 60, a larger frictional force is generated than in the braking screwing portion 61.

The braking screwing portion 61 is a braking female screw that is provided on an inner peripheral surface 63 of the rotation shaft 6 and screwed to the braking piston portion 8. Therefore, the braking piston portion 8 is provided with a male screw that is screwed to the braking female screw which is the braking screwing portion 61 of the rotation shaft 6. A screwing portion between the braking screwing portion 61 and the braking piston portion 8 is implemented by a ball screw 61a. The ball screw 61a is provided on the inner peripheral surface 63 of the rotation shaft 6 and screwed to the braking piston portion 8.

In the axial direction (A-direction), at least a part of the parking male screw forming the parking screwing portion 60 of the rotation shaft 6 and the braking female screw forming the braking screwing portion 61 of the rotation shaft 6 are formed in a range in which the two overlap each other.

As an example, a screw thread pitch in the axial direction of the parking screwing portion 60 of the rotation shaft 6 is equal to a screw thread pitch in the axial direction of the braking screwing portion 61 of the rotation shaft 6. Of course, a screw thread pitch in the axial direction of the female screw of the parking piston portion 7 is equal to a screw thread pitch in the axial direction of the male screw of the braking piston portion 8. A diameter of the female screw of the parking piston portion 7 is larger than a diameter of the male screw of the braking piston portion 8. Further, movement speeds of the parking piston portion 7 and the braking piston portion 8, which move simultaneously in opposite directions, are equal to each other.

Therefore, when the same electric power is used to move the parking piston portion 7 and press the brake pad 9a against the disc rotor 9b by the parking piston portion 7, and to move the braking piston portion 8 and press the brake pad 9a against the disc rotor 9b by the braking piston portion 8, and the two cases are compared, higher movement responsiveness can be obtained in the case of the braking piston portion 8. That is, the braking piston portion 8 can be moved more efficiently than the parking piston portion 7.

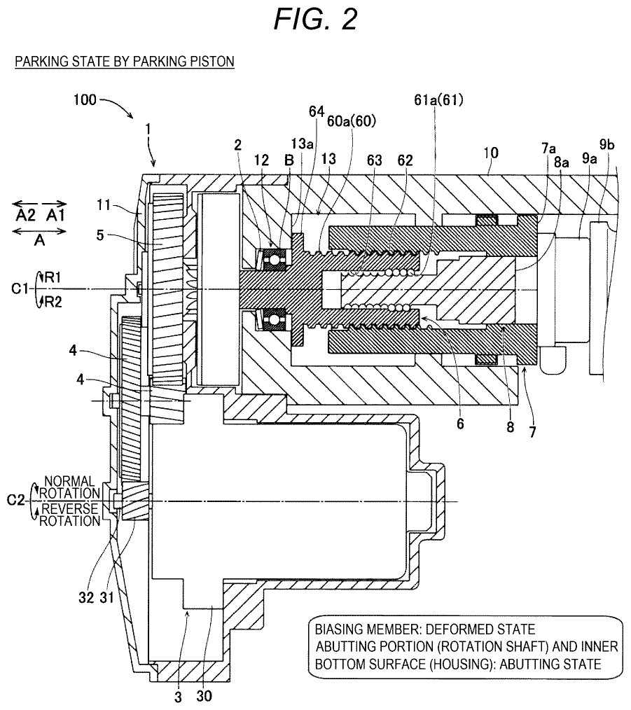

As shown in FIG. 2, the rotation shaft 6 slightly moves in a direction (A2-direction) opposite to the pressing direction (A1-direction) of the brake pad 9a by the parking piston portion 7 when receiving a reaction force caused by the parking piston portion 7 pressing the brake pad 9a against the disc rotor 9b.

The rotation shaft 6 includes the abutting portion 64. The abutting portion 64 abuts against the inner bottom surface 13a of the housing 1 when the rotation shaft 6 moves in the direction opposite to the pressing direction of the brake pad 9a. The abutting portion 64 is a flange portion that extends in a direction intersecting the axial direction and comes into surface contact with the inner bottom surface 13a of the housing 1. The abutting portion 64 is formed in an annular shape in which the central axis C1 is located at a center thereof.

### Configurations of Parking Piston Portion and Braking Piston Portion

The parking piston portion 7 illustrated in FIG. 2 moves in the axial direction (A1-direction) of the central axis C1 and presses the brake pad 9a when the rotation shaft 6 rotates in the one rotation direction (R1-direction) in a state in which the parking piston portion 7 is screwed to the parking screwing portion 60 of the rotation shaft 6. The parking piston portion 7 directly comes into contact with the brake pad 9a when pressing the brake pad 9a. The parking piston portion 7 switches the electric brake device from the parking release state to the parking state by pressing the brake pad 9a in contact with the parking piston portion 7 against the disc rotor 9b and locking the rotation of the rotation shaft 6 by a frictional force between the parking piston portion 7 and the parking screwing portion 60.

The parking piston portion 7 can be divided into a plurality of members in consideration of ease of assembly. As a specific example, although not illustrated, the parking piston portion 7 can be divided into two members, a member on one side and a member on the other side in the axial direction. A predetermined inclination inhibiting mechanism including a spring member for inhibiting inclination of the parking piston portion 7 relative to the opposed disc rotor 9b is provided between the two members constituting the parking piston portion 7.

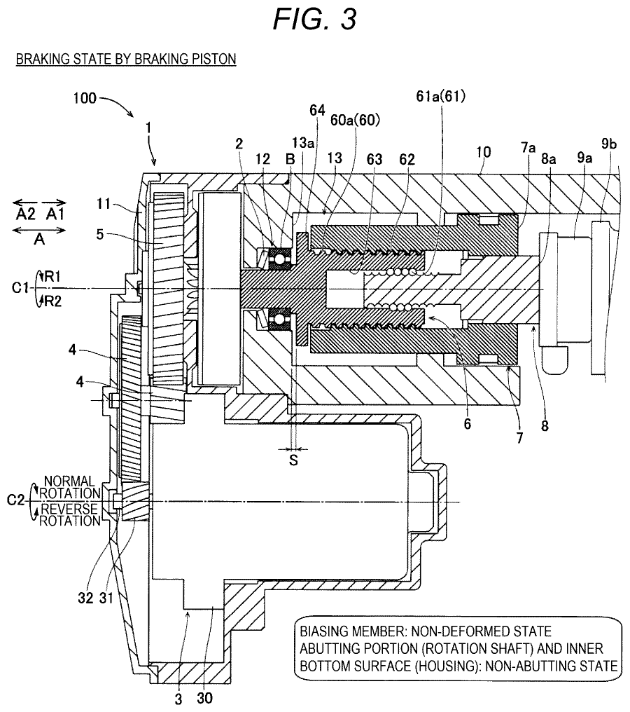

The braking piston portion 8 illustrated in FIG. 3 moves in a direction (A1-direction) opposite to the parking piston portion 7 along the axial direction of the central axis C1 together with the movement of the parking piston portion 7 in a direction away from the brake pad 9a in the axial direction and presses the brake pad 9a when the rotation shaft 6 rotates in the other rotation direction (R2-direction) opposite to the one rotation direction (R1-direction) in a state in which the braking piston portion 8 is screwed to the braking screwing portion 61 of the rotation shaft 6. The braking piston portion 8 directly comes into contact with the brake pad 9a when pressing the brake pad 9a. The braking piston portion 8 brakes the disc rotor 9b by pressing the brake pad 9a in contact with the braking piston portion 8 against the disc rotor 9b.

The pressing force with which the braking piston portion 8 presses the brake pad 9a is smaller than the pressing force with which the parking piston portion 7 presses the brake pad 9a. As an example, an area of an annular pressing surface 7a of the brake pad 9a which is an end surface for the parking piston portion 7 in the A1-direction is larger than an area of a circular pressing surface 8a for the brake pad 9a which is an end surface of the braking piston portion 8 in the A1-direction.

The parking piston portion 7 and the braking piston portion 8 are normally screwed to the parking screwing portion 60 and the braking screwing portion 61 of the rotation shaft 6, respectively. Therefore, the parking piston portion 7 and the braking piston portion 8 simultaneously move with the rotation of the rotation shaft 6. The parking screwing portion 60 and the braking screwing portion 61 of the rotation shaft 6 have spiral screw threads that are opposite to each other such that the movement directions of the parking piston portion 7 and the braking piston portion 8 along the axial direction (A-direction) are normally opposite to each other. In short, the parking piston portion 7 has one of a right screw and a left screw, and the braking piston portion 8 has the other one of the right screw and the left screw.

The parking piston portion 7 is formed in an annular shape when viewed from the axial direction (A-direction) of the central axis C1. The braking piston portion 8 is formed in a circular shape disposed inside the parking piston portion 7 when viewed in the axial direction. That is, the parking piston portion 7 comes into contact with the brake pad 9a at a position farther from the central axis C1 than the braking piston portion 8.

Although not illustrated, the parking piston portion 7 and the braking piston portion 8 are provided with a predetermined rotation prevention structure that prevents the parking piston portion 7 and the braking piston portion 8 from rotating around the central axis C1 with the rotation of the rotation shaft 6. As an example, the rotation prevention structure is a guide structure formed by engaging a protruding portion and a recessed portion that are provided in each of the parking piston portion 7, the braking piston portion 8, and the housing 1 and extend in the axial direction.

### Configurations of Brake Pad and Disc Rotor

The brake pad 9a and the disc rotor 9b illustrated in FIG. 1 are disposed on the A1-direction side of the parking piston portion 7 and the braking piston portion 8. A pair of brake pads 9a are provided to face each other in the axial direction (A-direction). The disc rotor 9b is disposed between the pair of brake pads 9a. The tire T is fixed to the disc rotor 9b outside the housing 1. That is, the disc rotor 9b rotates together with the tire T. The pair of brake pads 9a cause a braking force for reducing a torque of the disc rotor 9b (tire T) or a braking force for inhibiting an increase in the torque by being pressed against the disc rotor 9b using the driving force of the motor 3.

### Regarding Holding Force for Holding Parking State of Electric Brake Device

The holding force for holding the parking state of the electric brake device 100 will be described with reference to FIG. 2. Examples of the holding force for holding the parking state of the electric brake device 100 include two holding forces.

As described above, examples of the first holding force include the frictional force between the parking piston portion 7 and the parking screwing portion 60. The parking piston portion 7 switches the electric brake device from the parking release state to the parking state by locking the rotation of the rotation shaft 6 by the frictional force.

Examples of the second holding force include a frictional force between the housing 1 and the abutting portion 64 formed as the flange portion of the rotation shaft 6. Specifically, the rotation shaft 6 moves in a direction (A2-direction) opposite to the pressing direction (A1-direction) of the brake pad 9a against a biasing force of the biasing member 2 and causes the abutting portion 64 to abut against the housing 1 when receiving a reaction force caused by the parking piston portion 7 pressing the brake pad 9a against the disc rotor 9b. In addition to the frictional force between the parking screwing portion 60 and the parking piston portion 7, the abutting portion 64 maintains the parking state which is a state in which the rotation of the rotation shaft 6 is locked by the frictional force between the abutting portion 64 and the housing 1.

More specifically, when the parking piston portion 7 moves in the A1-direction with the rotation of the rotation shaft 6 and the pressing force for pressing the brake pad 9a against the disc rotor 9b increases, the parking piston portion 7 is in a state in which the parking piston portion 7 cannot move in the A1-direction any more. As a result, due to the reaction force from the disc rotor 9b side, a particularly large force for pressing the parking screwing portion 60 of the rotation shaft 6 in the A2-direction by the female screw of the parking piston portion 7 is generated. Then, as the reaction force increases, the force for pressing the parking screwing portion 60 of the rotation shaft 6 in the A2-direction becomes larger, and when the force reaches a magnitude at which the biasing member 2 can deform, the biasing member 2 is brought into a deformed state in which the biasing member 2 contracts in the A-direction from a non-deformed state (see FIG. 3).

Accordingly, the rotation shaft 6 slightly moves in the A2-direction so as to reduce a gap S (see FIG. 3) between the abutting portion 64 and the inner bottom surface 13a of the housing 1 against the biasing force of the biasing member 2. As a result, the abutting portion 64 of the rotation shaft 6 comes into surface contact with the inner bottom surface 13a of the housing 1. The electric brake device 100 inhibits the rotation of the rotation shaft 6 by a frictional force of a surface contact portion between the abutting portion 64 of the rotation shaft 6 and the inner bottom surface 13a of the housing 1, so that the parking state is more reliably maintained.

### Effects of First Embodiment

In the first embodiment, the following effects can be obtained.

In the first embodiment, as described above, the parking piston portion 7 and the braking piston portion 8 are provided. The parking piston portion 7 moves in the axial direction of the central axis C1 and presses the brake pad 9a when the rotation shaft 6 rotates in the one rotation direction in a state in which the parking piston portion 7 is screwed to the parking screwing portion 60 of the rotation shaft 6. The braking piston portion 8 moves along the axis together with the movement of the parking piston portion 7 in a direction away from the brake pad 9a in the axial direction and presses the brake pad 9a when the rotation shaft 6 rotates in the other rotation direction opposite to the one rotation direction in a state in which the braking piston portion 8 is screwed to the braking screwing portion 61 of the rotation shaft 6. Accordingly, when the rotation direction of the rotation shaft 6 is switched by the motor 3 which is the drive source, the parking piston portion 7 is moved, so that the parking state can be maintained. Further, when the rotation direction of the rotation shaft 6 is switched by the motor 3 which is the drive source, the braking piston portion 8 is moved, and the brake pad 9a is pressed against the disc rotor 9b, so that the disc rotor 9b (tire T) can be braked. That is, the braking and parking states can be maintained by only one motor 3. Therefore, an electric solenoid according to the related art for maintaining the parking state is not required. As a result, the number of components in the drive source for braking and parking brake can be reduced.

In the first embodiment, as described above, the parking screwing portion 60 is the parking male screw that is provided on the outer peripheral surface 62 of the rotation shaft 6 and screwed to the parking piston portion 7, and the braking screwing portion 61 is the ball screw 61a that is provided on the inner peripheral surface 63 of the rotation shaft 6 and screwed to the braking piston portion 8. Accordingly, the parking piston portion 7 can be screwed to the parking male screw of the rotation shaft 6 from the outer peripheral side, and therefore, an increase in the size of the rotation shaft 6 can be inhibited. The ball screw 61a can cause the braking piston portion 8 to smoothly move relative to the braking screwing portion 61 of the rotation shaft 6, and therefore, the responsiveness of the braking piston portion 8 can be improved.

In the first embodiment, as described above, the housing 1 that accommodates the rotation shaft 6, the parking piston portion 7, and the braking piston portion 8 is further provided. The rotation shaft 6 moves in the direction opposite to the pressing direction of the brake pad 9a by the parking piston portion 7 when receiving the reaction force caused by the parking piston portion 7 pressing the brake pad 9a against the disc rotor 9b. The rotation shaft 6 includes the abutting portion 64 that comes into contact with the housing 1 when the rotation shaft 6 moves in the direction opposite to the pressing direction, and the abutting portion 64 maintains the parking state which is a state in which the rotation of the rotation shaft 6 is locked by the frictional force between the parking screwing portion 60 and the parking piston portion 7 and the frictional force between the abutting portion 64 and the housing 1. Accordingly, the holding force for holding the parking state can become larger by the abutting portion 64 that abuts against the housing 1, and therefore, the parking state can be more stably held.

In the first embodiment, as described above, the parking piston portion 7 and the braking piston portion 8 come into direct contact with the brake pad 9a and press the brake pad 9a. The parking piston portion 7 is formed in an annular shape when viewed in the axial direction of the central axis C1, and the braking piston portion 8 is formed in a circular shape arranged inside the parking piston portion 7 when viewed in the axial direction. Accordingly, the screwing portion between the parking piston portion 7 and the rotation shaft 6 can be disposed on the outer side (outer peripheral side) than the screwing portion between the braking piston portion 8 and the rotation shaft 6, and therefore, a screw lead angle of the parking screwing portion 60 can be reduced by ensuring a relatively large radial distance from the central axis C1 of the rotation shaft 6 to the screwing portion between the parking piston portion 7 and the rotation shaft 6. As a result, the frictional force of the parking screwing portion 60 can be increased.

In the first embodiment, as described above, the rotation shaft 6 is formed in a cylindrical shape in which the parking male screw is provided on the outer peripheral surface 62. The braking screwing portion 61 is a braking female screw that is provided on the inner peripheral surface 63 of the rotation shaft 6 and screwed to the braking piston portion 8. At least a part of the parking male screw and the braking female screw are formed in a range where they overlap each other in the axial direction. Accordingly, the parking male screw of the rotation shaft 6 and the braking female screw of the rotation shaft 6 can overlap each other in the axial direction, and therefore, the size of the rotation shaft 6 in the axial direction can be reduced, and a size of the device can be reduced in the axial direction.

In the first embodiment, as described above, the biasing member 2 disposed between the housing 1 and the rotation shaft 6 in the axial direction is further provided. The rotation shaft 6 moves in the direction opposite to the pressing direction of the brake pad 9a against the biasing force of the biasing member 2 and causes the abutting portion 64 to abut against the housing 1 when receiving the reaction force caused by the parking piston portion 7 pressing the brake pad 9a against the disc rotor 9b. Accordingly, when the rotation shaft 6 receives, by the biasing member 2, a reaction force caused by the parking piston portion 7 pressing the brake pad 9a against the disc rotor 9b, the biasing member 2 first deforms to cause the abutting portion 64 of the rotation shaft 6 to abut against the housing 1. That is, during braking in which the rotation shaft 6 receives a relatively small reaction force from the braking piston portion 8 side, the abutting portion 64 of the rotation shaft 6 can be inhibited from abutting against the housing 1 due to deformation of the biasing member 2.

In the first embodiment, as described above, the abutting portion 64 is a flange portion that extends in a direction intersecting the axial direction and comes into surface contact with the inner bottom surface 13a of the housing 1. Accordingly, a large area of a contact surface between the housing 1 and the rotation shaft 6 that generates a holding force for holding the parking state can be ensured by the abutting portion 64 implemented by the flange portion. As a result, a holding force for holding a larger parking state can be generated.

### Second Embodiment

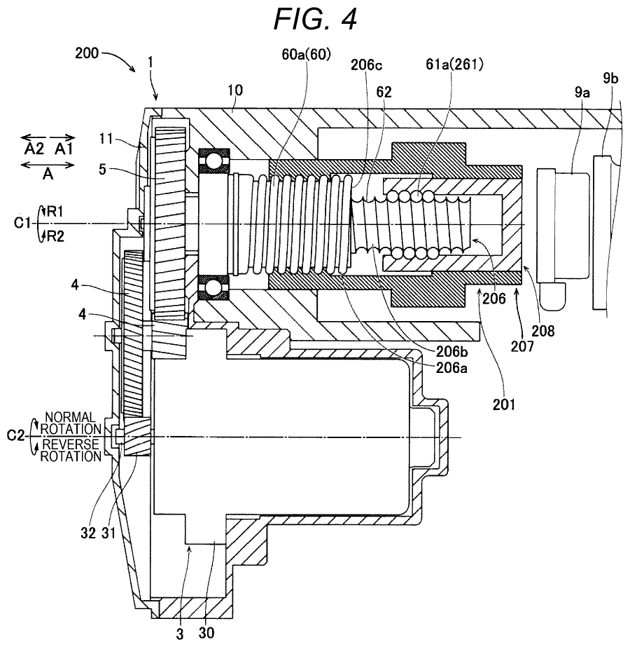

A second embodiment will be described with reference to FIG. 4. In the second embodiment, unlike the first embodiment in which the braking screwing portion 61 of the rotation shaft 6 screwed to the braking piston portion 8 is implemented by a female screw, an example in which a braking screwing portion 261 screwed to a braking piston portion 208 is implemented by a male screw will be described. In the drawings, the same components as those of the first embodiment are denoted by the same reference numerals.

The electric brake device 200 according to the second embodiment includes a rotation shaft 206 and a piston 201. The piston 201 includes a parking piston portion 207 and the braking piston portion 208.

The rotation shaft 206 includes the parking screwing portion 60 formed by a parking female screw and the braking screwing portion 261 formed by a braking female screw.

The braking screwing portion 261 is a braking male screw that is provided on the outer peripheral surface 62 of the rotation shaft 206 and screwed to the braking piston portion 208.

The rotation shaft 206 includes a parking rotation shaft portion 206a provided with a parking male screw that forms the parking screwing portion 60. The rotation shaft 206 includes a braking rotation shaft portion 206b that is connected to one end 206c of the parking rotation shaft portion 206a in the axial direction (A1-direction) and is provided with a braking male screw forming the braking screwing portion 261.

A diameter of the parking rotation shaft portion 206a is larger than a diameter of the braking rotation shaft portion 206b. Therefore, the rotation shaft 206 is formed in a stepped shape whose A1-direction side becomes narrower due to the parking rotation shaft portion 206a and the braking rotation shaft portion 206b. In the axial direction, the parking male screw forming the parking screwing portion 60 of the rotation shaft 206 and the braking male screw forming the braking screwing portion 261 of the rotation shaft 206 are formed in a range where they are shifted so as not to overlap each other.

The parking piston portion 207 has a female screw that is screwed to the parking screwing portion 60 (parking male screw) of the rotation shaft 206. The braking piston portion 208 has a female screw that is screwed to the braking screwing portion 261 (braking male screw) of the rotation shaft 206.

Other configurations of the second embodiment are the same as those of the first embodiment.

### Effects of Second Embodiment

In the second embodiment, the following effects can be obtained.

In the second embodiment, as described above, the parking piston portion 207 and the braking piston portion 208 are provided. The parking piston portion 207 moves in the axial direction of the central axis C1 and presses the brake pad 9a when the rotation shaft 206 rotates in the one rotation direction in a state in which the parking piston portion 207 is screwed to the parking screwing portion 60 of the rotation shaft 206. The braking piston portion 208 moves along the axis together with the movement of the parking piston portion 207 in a direction away from the brake pad 9a in the axial direction and presses the brake pad 9a when the rotation shaft 206 rotates in the other rotation direction opposite to the one rotation direction in a state in which the braking piston portion 208 is screwed to the braking screwing portion 261 of the rotation shaft 206. Accordingly, as in the first embodiment, the number of components in the drive source for braking and parking brake can be reduced.

In the second embodiment, as described above, the braking screwing portion 261 is a braking male screw that is provided on the outer peripheral surface 62 of the rotation shaft 206 and screwed to the braking piston portion 208. The rotation shaft 206 includes the parking rotation shaft portion 206a provided with the parking male screw and the braking rotation shaft portion 206b that is connected to the one end 206c of the parking rotation shaft portion 206a in the axial direction and is provided with the braking male screw. The parking male screw and the braking male screw are formed in a range where they are shifted so as not to overlap each other in the axial direction. Accordingly, the parking piston portion 207 and the braking piston portion 208 can be disposed on the outer peripheral side of the rotation shaft 206, and therefore, the size of the rotation shaft 206 in the direction intersecting the axial direction can be reduced, and the size of the device can be reduced in the direction intersecting the axial direction.

Other effects of the second embodiment are the same as those of the first embodiment.

### Third Embodiment

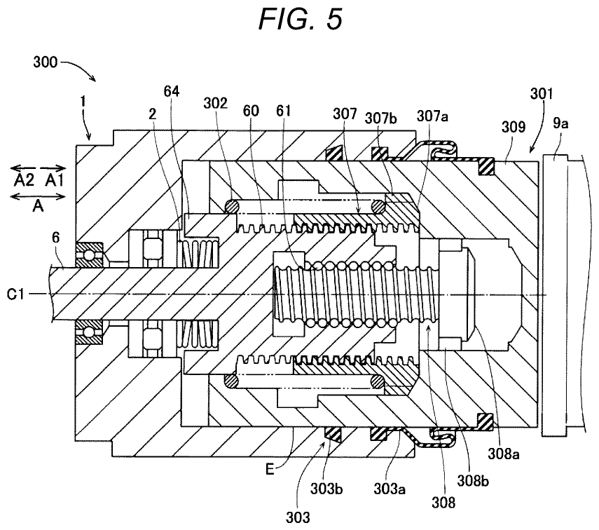

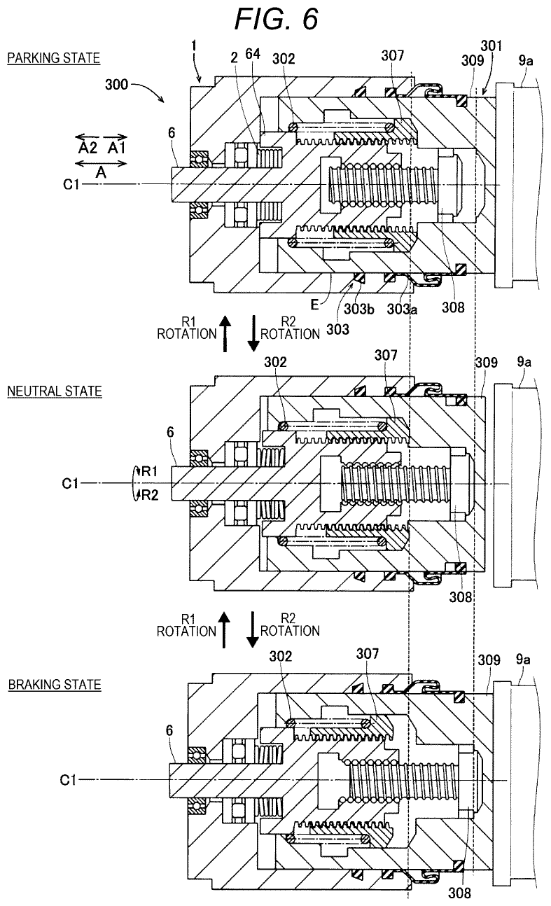

A third embodiment will be described with reference to FIGS. 5 and 6. In the third embodiment, unlike the first embodiment in which two members are brought into direct contact with the brake pad 9a from the rotation shaft 6 side, an example in which one member is brought into direct contact with the brake pad 9a from the rotation shaft 6 side will be described. In the drawings, the same components as those of the first embodiment are denoted by the same reference numerals.

An electric brake device 300 according to the third embodiment shown in FIGS. 5 and 6 includes the rotation shaft 6, a piston 301, a biasing member 302, and a seal member 303. The piston 301 includes a parking piston portion 307, a braking piston portion 308, and a pad contact member 309.

The parking piston portion 307 moves in the axial direction (A1-direction) of the central axis C1 and presses the brake pad 9a when the rotation shaft 6 rotates in one rotation direction (R1-direction) around the central axis C1 in a state in which the parking piston portion 307 is screwed to the parking screwing portion 60. The parking piston portion 307 is disposed around the central axis C1 and is formed in a cylindrical shape extending in the A-direction. The parking piston portion 307 has a flange-shaped contact portion 307a, which is a part in contact with the pad contact member 309, on an end portion in the A1-direction. The contact portion 307a is provided with a guide portion 307b. The guide portion 307b guides the movement of the parking piston portion 307 in the A-direction while restricting the rotation of the parking piston portion 307 around the central axis C1 relative to the pad contact member 309.

The braking piston portion 308 moves in the direction (A1-direction) opposite to the parking piston portion 307 along the axial direction of the central axis C1 and presses the brake pad 9a when the rotation shaft 6 rotates in the other rotation direction (R2-direction) opposite to the one rotation direction around the central axis C1 in a state in which the braking piston portion 308 is screwed to the braking screwing portion 61. The braking piston portion 308 normally moves in the direction opposite to the pad contact member 309 at the same time as the movement of the pad contact member 309 in the A-direction. The braking piston portion 308 is formed in a columnar shape extending in the A-direction along the central axis C1. The braking piston portion 308 has a flange-shaped contact portion 308a, which is a part in contact with the pad contact member 309, on an end portion in the A1-direction. The contact portion 308a is provided with a guide portion 308b. The guide portion 308b guides the movement of the braking piston portion 308 in the A-direction while restricting the rotation of the braking piston portion 308 around the central axis C1 relative to the pad contact member 309.

The pad contact member 309 is a single structure that comes into contact with the brake pad 9a. The pad contact member 309 is provided as a common structure for the parking piston portion 307 and the braking piston portion 308 to cover the parking piston portion 307 and the braking piston portion 308 from the brake pad 9a side. The pad contact member 309 is formed in a hollow cylindrical shape in which an end portion in the A1-direction is closed and an end portion in the A2-direction is opened. That is, the pad contact member 309 is formed in a horizontal cup shape in which an opening is disposed on the A2-direction side. The pad contact member 309 having a cylindrical shape is disposed around the central axis C1. The pad contact member 309 is fitted into the inner peripheral surface of the housing 1 in a state in which the pad contact member 309 is movable in the A-direction. An outer peripheral surface of the pad contact member 309 is provided with a guide portion (not illustrated) that guides the movement of the pad contact member 309 in the A-direction while restricting the rotation of the pad contact member 309 around the central axis C1 relative to the housing 1.

The parking piston portion 307 and the braking piston portion 308 come into contact with the brake pad 9a via the pad contact member 309 and press the brake pad 9a.

Here, it is assumed that the electric brake device 300 is in a parking release state in which there is no braking by the braking piston portion 308 and the disc rotor 9b (tire T (see FIG. 1)) is not locked by the parking piston portion 307. This state is referred to as a neutral state.

A case where the neutral state is switched to the braking state (the state in which the disc rotor 9b (tire T) is braked) will be described. In this case, the rotation shaft 6 rotates in the other rotation direction (R2-direction) opposite to the one rotation direction around the central axis C1. Accordingly, the braking piston portion 308 moves in the A1-direction toward the brake pad 9a. At the same time, the parking piston portion 307 moves in the A2-direction. Then, the braking piston portion 308 pushes the pad contact member 309 forward in the A1-direction while being in contact with the pad contact member 309. As a result, the braking piston portion 308 comes into contact with the brake pad 9a via the pad contact member 309 and presses the brake pad 9a.

Next, a case where the neutral state (parking release state) is switched to the parking state will be described. In this case, the rotation shaft 6 rotates in the one rotation direction (R1-direction) around the central axis C1. Accordingly, the parking piston portion 307 moves in the A1-direction toward the brake pad 9a. At the same time, the braking piston portion 308 moves in the A2-direction. Then, the parking piston portion 307 pushes the pad contact member 309 forward in the A1-direction while being in contact with the pad contact member 309. As a result, the parking piston portion 307 comes into contact with the brake pad 9a via the pad contact member 309 and presses the brake pad 9a. When the rotation shaft 6 further rotates and presses the pad contact member 309 against the brake pad 9a via the parking piston portion 307 with a larger force, the parking piston portion 307 is pressed in the A2-direction by the reaction force from the brake pad 9a. The rotation shaft 6 is also pressed in the A2-direction by this reaction force. When the reaction force becomes larger than the biasing force of the biasing member 2, the abutting portion 64 of the rotation shaft 6 is moved in the A2-direction against the biasing force of the biasing member 2 and comes into contact with the housing 1. As an example, the biasing member 2 is formed by a compression coil spring.

The biasing member 302 biases the parking piston portion 307 and the braking piston portion 308 toward the brake pad 9a in the A1-direction and biases the pad contact member 309 in a direction (A2-direction) opposite to the parking piston portion 307 and the braking piston portion 308. The biasing member 302 is disposed inside the pad contact member 309. The biasing member 302 is formed by an elastic member that generates a biasing force in the A-direction. As an example, the biasing member 302 is formed by a compression coil spring. The biasing member 302 is disposed around the central axis C1. An A2-direction end portion of the biasing member 302 abuts against the pad contact member 309, and an A1-direction end portion thereof abuts against the parking piston portion 307. That is, the biasing member 302 constantly presses the pad contact member 309 in the A2-direction, and constantly presses the parking piston portion 307 in the A1-direction. In short, the biasing member 302 always applies an outward pressure in the A-direction to the pad contact member 309 and the parking piston portion 307 between the pad contact member 309 and the parking piston portion 307. The braking piston portion 308 is connected to the parking piston portion 307 via the rotation shaft 6 that is slightly movable in the A-direction. Therefore, the braking piston portion 308 also constantly receives the applied pressure in the A1-direction from the biasing member 302.

The pad contact member 309 constantly receives a pressing force for pressing the pad contact member 309 in the A2-direction against the parking piston portion 307 by the biasing member 302. The pressing force is uniform around the central axis C1. When the use states of the parking piston portion 307 and the braking piston portion 308 are switched by moving the parking piston portion 307 and the braking piston portion 308, the pad contact member 309, the parking piston portion 307, and the braking piston portion 308 can be prevented from rattling by the uniform pressing force.

When the electric brake device returns from the parking state to the neutral state by rotating the rotation shaft 6, the pad contact member 309 moves in the A2-direction together with the parking piston portion 307 by the biasing member 302. Similarly, when the electric brake device returns from the braking state to the neutral state by rotating the rotation shaft 6, the pad contact member 309 moves in the A2-direction together with the braking piston portion 308 by the biasing member 302.

The seal member 303 is provided at an interface E between an outer peripheral surface of the pad contact member 309 and an inner peripheral surface of the housing 1. That is, the seal member 303 is provided at the interface E, which is a position where foreign matter or the like is prevented from entering the device. In the electric brake device 300, the interface E where the seal member 303 is to be provided in order to prevent foreign matter or the like from entering from the outside is only one portion between the pad contact member 309 and the housing 1.

As an example, the seal member 303 includes a bellows-shaped seal 303a disposed in an end portion of the housing 1 in the A1-direction. The bellows-shaped seal 303a is formed by an elastic member. The bellows-shaped seal 303a is formed in an annular shape in which the central axis C1 is disposed at the center. One end of the bellows-shaped seal 303a is disposed in a recessed portion of an outer peripheral surface of the pad contact member 309, and the other end is disposed in a recessed portion of an inner peripheral surface of the housing 1. Further, as an example, the seal member 303 includes a rectangular seal 303b disposed on the A2-direction side of the bellows-shaped seal 303a at the interface E. The rectangular seal 303b is formed in an annular shape in which the central axis C1 is disposed at the center. The rectangular seal 303b is formed by an elastic member.

Other configurations of the third embodiment are the same as those of the first embodiment.

### Effects of Third Embodiment

In the third embodiment, the following effects can be obtained.

In the third embodiment, as described above, the parking piston portion 307 and the braking piston portion 308 are provided. The parking piston portion 307 moves in the axial direction of the central axis C1 and presses the brake pad 9a when the rotation shaft 6 rotates in the one rotation direction in a state in which the parking piston portion 307 is screwed to the parking screwing portion 60 of the rotation shaft 6. The braking piston portion 308 moves along the axis together with the movement of the parking piston portion 307 in a direction away from the brake pad 9a in the axial direction and presses the brake pad 9a when the rotation shaft 6 rotates in the other rotation direction opposite to the one rotation direction in a state in which the braking piston portion 308 is screwed to the braking screwing portion 61 of the rotation shaft 6. Accordingly, as in the first embodiment, the number of components in the drive source for braking and parking brake can be reduced.

In the third embodiment, as described above, the piston 301 includes the single pad contact member 309 that is provided as a common structure for the parking piston portion 307 and the braking piston portion 308 to cover the parking piston portion 307 and the braking piston portion 308 from a brake pad 9a side and comes into contact with the brake pad 9a, and the parking piston portion 307 and the braking piston portion 308 come into contact with the brake pad 9a via the pad contact member 309 and press the brake pad 9a. Accordingly, compared with a case where a plurality of members are switched to press the brake pad 9a, a large contact area between the brake pad 9a and the pad contact member 309, which is a member that presses the brake pad 9a, can be ensured, and therefore, a frictional force can be effectively generated between the pad contact member 309 and the brake pad 9a to maintain the braking and parking states.

In the third embodiment, as described above, the biasing member 302 that biases the parking piston portion 307 and the braking piston portion 308 toward the brake pad 9a and biases the pad contact member 309 in the direction opposite to the parking piston portion 307 and the braking piston portion 308 is further provided. Accordingly, the biasing member 302 can apply a pressure to the parking piston portion 307, the braking piston portion 308, and the pad contact member 309 in a direction in which they are away from one another, and therefore, the pad contact member 309, the parking piston portion 307, and the braking piston portion 308 can be prevented from being displaced relative to one another when the braking state and the parking state are switched.

Other effects of the third embodiment are the same as those of the first embodiment.

### Modification

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

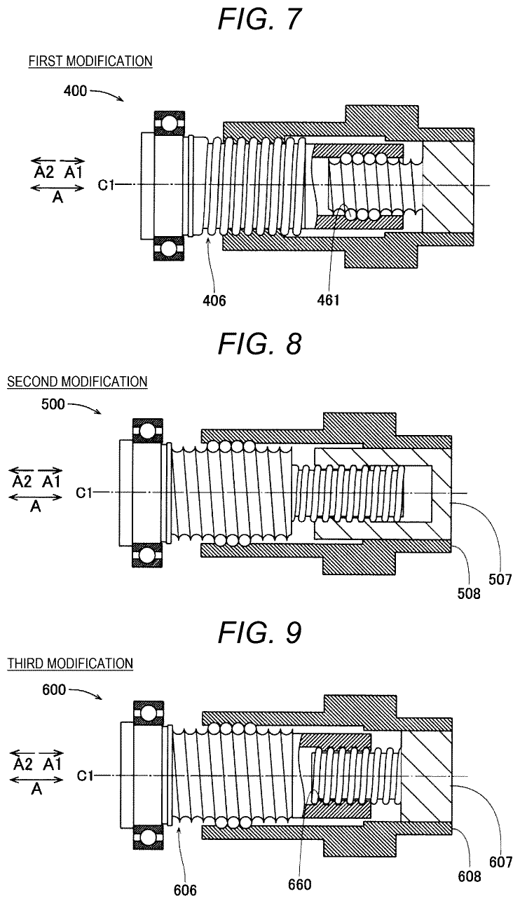

For example, in the first to third embodiments, the example in which the braking screwing portion of the rotation shaft is formed by the braking male screw has been described, but this disclosure is not limited thereto. In this disclosure, as in an electric brake device 400 according to a first modification shown in FIG. 7, a braking screwing portion 461 of a rotation shaft 406 may be formed by a braking female screw.

In the first and second embodiments, the example in which the parking piston portion is formed in an annular shape, and the braking piston portion is disposed inside the parking piston portion has been described, but this disclosure is not limited thereto. In this disclosure, as in an electric brake device 500 according to a second modification shown in FIG. 8, a braking piston portion 508 may be formed in an annular shape, and a parking piston portion 507 may be disposed inside the braking piston portion 508. In this case, as an example, the rotation shaft is formed in a stepped shape similar to that of the second embodiment.

Further, as in an electric brake device 600 according to a third modification shown in FIG. 9, a parking screwing portion 660 of a rotation shaft 606 may be formed by a parking female screw, a braking piston portion 608 may be formed in an annular shape, and a parking piston portion 607 may be disposed inside the braking piston portion 608.

In the first to third embodiments, the example in which at least one of the parking screwing portion of the rotation shaft and the braking screwing portion of the rotation shaft is formed by a male screw has been described, but this disclosure is not limited thereto. In this disclosure, both the parking screwing portion of the rotation shaft and the braking screwing portion of the rotation shaft may be formed by female screws.

In the first to third embodiments, the example in which the ball screw is used as the braking screwing portion of the rotation shaft has been described, but this disclosure is not limited thereto. In this disclosure, a sliding screw, a trapezoidal screw, or the like may be used as the braking screwing portion of the rotation shaft.

In the first to third embodiments, the example in which the trapezoidal screw is used as the parking screwing portion of the rotation shaft has been described, but this disclosure is not limited thereto. In this disclosure, a sliding screw, a ball screw, or the like may be used as the parking screwing portion of the rotation shaft.

In the first to third embodiments, the example in which the driving force of the motor is indirectly transmitted to the rotation shaft via the plurality of transmission gears has been described, but this disclosure is not limited thereto. In this disclosure, the driving force of the motor may be directly transmitted to the rotation shaft without passing through the transmission gear.

In the first and second embodiments, the example in which the biasing member for biasing the rotation shaft is implemented by a disc spring, but this disclosure is not limited thereto. In this disclosure, the biasing member for biasing the rotation shaft may be implemented by a coil spring, a rubber member, or the like.

In the first to third embodiments, the example in which the parking piston portion moves in the A1-direction during the normal rotation of the motor, but this disclosure is not limited thereto. In this disclosure, the parking piston portion may move in the A2-direction during the normal rotation of the motor.

In the first and second embodiments, the example in which the parking piston portion is formed in an annular shape has been described, but this disclosure is not limited thereto. In this disclosure, the parking piston portion may be formed in a C shape or the like.

In the first to third embodiments, the example in which the electric brake device includes the biasing member that biases the rotation shaft has been described, but this disclosure is not limited thereto. In this disclosure, the electric brake device may not include the biasing member for biasing the rotation shaft.

According to an aspect of this disclosure, an electric brake device includes: a motor; a rotation shaft provided with a parking screwing portion and a braking screwing portion having a common central axis, the rotation shaft being rotated by the motor; and a piston including a parking piston portion and a braking screwing portion, the parking piston portion moving in an axial direction of the central axis and pressing a brake pad when the rotation shaft rotates in one rotation direction in a state in which the parking piston portion is screwed to the parking screwing portion, and the braking piston portion moving in the axial direction together with a movement of the parking piston portion in a direction away from the brake pad in the axial direction and pressing the brake pad when the rotation shaft rotates in the other rotation direction opposite to the one rotation direction in a state in which the braking piston portion is screwed to the braking screwing portion.

In the electric brake device according to an aspect of this disclosure, as described above, the parking piston portion and the braking piston portion are provided. The parking piston portion moves in the axial direction of the central axis and presses the brake pad when the rotation shaft rotates in the one rotation direction in a state in which the parking piston portion is screwed to the parking screwing portion of the rotation shaft. The braking piston portion moves along the axis together with the movement of the parking piston portion in a direction away from the brake pad in the axial direction and presses the brake pad when the rotation shaft rotates in the other rotation direction opposite to the one rotation direction in a state in which the braking piston portion is screwed to the braking screwing portion of the rotation shaft. Accordingly, when the rotation direction of the rotation shaft is switched by the motor which is the drive source, the parking piston portion is moved, so that the parking state can be maintained. Further, when the rotation direction of the rotation shaft is switched by the motor which is the drive source, the braking piston portion is moved, and the brake pad is pressed against the disc rotor, so that the disc rotor (tire) can be braked. That is, the braking and parking states can be maintained by only one motor. Therefore, an electric solenoid according to the related art for maintaining the parking state is not required. As a result, the number of components in the drive source for braking and parking brake can be reduced.

In the electric brake device according to an aspect of this disclosure, the piston may include the single pad contact member that is provided as a common structure for the parking piston portion and the braking piston portion to cover the parking piston portion and the braking piston portion from a brake pad side and come into contact with the brake pad, and the parking piston portion and the braking piston portion may come into contact with the brake pad via the pad contact member and press the brake pad.

According to this configuration, compared with a case where a plurality of members are switched to press the brake pad, a large contact area between the brake pad and the pad contact member, which is a member that presses the brake pad, can be ensured, and therefore, a frictional force can be effectively generated between the pad contact member and the brake pad to maintain the braking and parking states.

In the electric brake device according to an aspect of this disclosure, the parking screwing portion may be a parking male screw that is provided on an outer peripheral surface of the rotation shaft and screwed to the parking piston portion, and the braking screwing portion may be a ball screw that is provided on an inner peripheral surface of the rotation shaft and screwed to the braking piston portion.

According to this configuration, the parking piston portion can be screwed to the parking male screw of the rotation shaft from the outer peripheral side, and therefore, an increase in the size of the rotation shaft can be inhibited. The ball screw can cause the braking piston portion to smoothly move relative to the braking screwing portion of the rotation shaft, and therefore, the responsiveness of the braking piston portion can be improved.

The electric brake device according to an aspect of this disclosure may further include a housing configured to accommodate the rotation shaft, the parking piston portion, and the braking piston portion. The rotation shaft may move in a direction opposite to a pressing direction of the brake pad by the parking piston portion when receiving a reaction force caused by the parking piston portion pressing the brake pad against a disc rotor, and the rotation shaft may include an abutting portion that abuts against the housing when the rotation shaft moves in the direction opposite to the pressing direction.

According to this configuration, the holding force for holding the parking state can become larger by the abutting portion that abuts against the housing, and therefore, the parking state can be more stably held.

In the electric brake device according to an aspect, the following configuration may also be considered.

### APPENDIX 1

In the electric brake device, the parking piston portion and the braking piston portion may come into direct contact with the brake pad and press the brake pad. The parking piston portion is formed in an annular shape when viewed in the axial direction of the central axis, and the braking piston portion is formed in a circular shape arranged inside the parking piston portion when viewed in the axial direction of the central axis.

According to this configuration, the screwing portion between the parking piston portion and the rotation shaft can be disposed on the outer side (outer peripheral side) relative to the screwing portion between the braking piston portion and the rotation shaft, and therefore, a screw lead angle of the parking screwing portion can be reduced by ensuring a relatively large radial distance from the central axis of the rotation shaft to the screwing portion between the parking piston portion and the rotation shaft. As a result, the frictional force of the parking screwing portion can be increased.

### APPENDIX 2

In the configuration in which the parking screwing portion is a parking male screw that is provided on the outer peripheral surface of the rotation shaft and screwed to the parking piston portion, the rotation shaft may be formed in a cylindrical shape in which the parking male screw is provided on the outer peripheral surface. The braking screwing portion may be a braking female screw that is provided on the inner peripheral surface of the rotation shaft and screwed to the braking piston portion. At least a part of the parking male screw and the braking female screw may be formed in a range where they overlap each other in the axial direction.

According to this configuration, the parking male screw of the rotation shaft and the braking female screw of the rotation shaft can overlap each other in the axial direction, and therefore, the size of the rotation shaft in the axial direction can be reduced, and a size of the device can be reduced in the axial direction.

### APPENDIX 3

In the configuration in which the parking screwing portion is a parking male screw that is provided on the outer peripheral surface of the rotation shaft and screwed to the parking piston portion, the braking screwing portion may be a braking male screw that is provided on the outer peripheral surface of the rotation shaft and screwed to the braking piston portion. The rotation shaft may include the parking rotation shaft portion provided with the parking male screw and the braking rotation shaft portion that is connected to the one end of the parking rotation shaft portion in the axial direction and is provided with the braking male screw. The parking male screw and the braking male screw may be formed in a range where they are shifted so as not to overlap each other in the axial direction.

According to this configuration, the parking piston portion and the braking piston portion can be disposed on the outer peripheral side of the rotation shaft, and therefore, the size of the rotation shaft in the direction intersecting the axial direction can be reduced, and the size of the device can be reduced in the direction intersecting the axial direction.

### APPENDIX 4

In the configuration in which the housing is provided and the rotation shaft includes the abutting portion, the biasing member disposed between the housing and the rotation shaft in the axial direction may be further provided. The rotation shaft may move in the direction opposite to the pressing direction of the brake pad against the biasing force of the biasing member and cause the abutting portion to abut against the housing when receiving the reaction force caused by the parking piston portion pressing the brake pad against the disc rotor.

According to this configuration, when the rotation shaft receives, by the biasing member, a reaction force caused by the parking piston portion pressing the brake pad against the disc rotor, the biasing member first deforms to cause the abutting portion of the rotation shaft to abut against the housing. That is, during braking in which the rotation shaft receives a relatively small reaction force from the braking piston portion side, it is possible to inhibit the abutting portion of the rotation shaft from abutting against the housing due to deformation of the biasing member.

### APPENDIX 5

In a configuration in which the housing is provided and the rotation shaft includes the abutting portion, the abutting portion may be a flange portion that extends in a direction intersecting the axial direction and comes into surface contact with the inner bottom surface of the housing.

According to this configuration, a large area of a contact surface between the housing and the rotation shaft that generates a holding force for holding the parking state can be ensured by the abutting portion implemented by the flange portion. As a result, a larger holding force for holding a parking state can be generated.

### APPENDIX 6

In the configuration in which the piston includes the pad contact member, the biasing member that biases the parking piston portion and the braking piston portion toward the brake pad and biases the pad contact member in the direction opposite to the parking piston portion and the braking piston portion may be further provided.

According to this configuration, the biasing member can apply a pressure to the parking piston portion, the braking piston portion, and the pad contact member in a direction in which they are away from one another, and therefore, the pad contact member, the parking piston portion, and the braking piston portion can be prevented from being displaced relative to one another when the braking state and the parking state are switched.

In this disclosure, the number of components in the drive source for braking and parking brake can be reduced.

What is claimed is:

1. An electric brake device comprising:
a motor;
a rotation shaft provided with a parking screwing portion and a braking screwing portion having a common central axis, the rotation shaft being rotated by the motor; and
a piston including a parking piston portion and a braking screwing portion, the parking piston portion moving in an axial direction of the central axis and pressing a brake pad when the rotation shaft rotates in one rotation direction in a state in which the parking piston portion is screwed to the parking screwing portion, and the braking piston portion moving in the axial direction together with a movement of the parking piston portion in a direction away from the brake pad in the axial direction and pressing the brake pad when the rotation shaft rotates in the other rotation direction opposite to the one rotation direction in a state in which the braking piston portion is screwed to the braking screwing portion.

2. The electric brake device according to claim 1, wherein
the piston includes a single pad contact member that is provided as a common structure for the parking piston portion and the braking piston portion to cover the parking piston portion and the braking piston portion from a brake pad side and comes into contact with the brake pad, and
the parking piston portion and the braking piston portion come into contact with the brake pad via the pad contact member and press the brake pad.

3. The electric brake device according to claim 1, wherein
the parking screwing portion is a parking male screw that is provided on an outer peripheral surface of the rotation shaft and screwed to the parking piston portion, and
the braking screwing portion is a ball screw that is provided on an inner peripheral surface of the rotation shaft and screwed to the braking piston portion.

4. The electric brake device according to claim 1, further comprising:
a housing configured to accommodate the rotation shaft, the parking piston portion, and the braking piston portion, wherein
the rotation shaft moves in a direction opposite to a pressing direction of the brake pad by the parking piston portion when receiving a reaction force caused by the parking piston portion pressing the brake pad against a disc rotor, and
the rotation shaft includes an abutting portion that abuts against the housing when the rotation shaft moves in the direction opposite to the pressing direction.
